(19) United States
(12) Patent Application Publication
(10) Pub. No.: US 2025/0224251 A1
(43) Pub. Date: Jul. 10, 2025

(54) CAMERA BASED LOCALIZATION, MAPPING, AND MAP LIVE UPDATE CONCEPT

(71) Applicant: VALEO SCHALTER UND SENSOREN GMBH, Bietigheim-Bissingen (DE)

(72) Inventors: Thomas Heitzmann, Bietigheim-Bissingen (DE); Xinhua Xiao, Troy, MI (US); Lihao Wang, Troy, MI (US); Deep Doshi, Troy, MI (US)

(73) Assignee: VALEO SCHALTER UND SENSOREN GMBH, Bietigheim-Bissingen (DE)

(21) Appl. No.: 18/405,459

(22) Filed: Jan. 5, 2024

(51) Int. Cl. G01C 21/00; G01C 21/30; G06T 7/73; G06V 10/10; G06V 20/58

(52) U.S. Cl. CPC G01C 21/3848; G01C 21/30; G01C 21/3822; G06T 7/73; G06V 10/16; G06V 20/58; G06T 2207/10016; G06T 2207/20212; G06T 2207/30256

(57) ABSTRACT

A system for generating a map of a paved surface for a vehicle and localizing the vehicle on the map of the paved surface includes an imaging sensor, a vehicle odometry sensor, a memory, a processor, and a transceiver. The imaging sensor captures a series of image frames. The vehicle odometry sensor measures an orientation, a velocity, and an acceleration of the vehicle. The memory stores a mapping engine as computer readable code. The processor executes the mapping engine to generate a map. The transceiver uploads the map to a server such that the map is accessed by a second vehicle that uses the map to traverse the external environment.

### BACKGROUND

In recent years, the field of Simultaneous Localization and Mapping (SLAM) has become pivotal in the domain of spatial mapping technology. As is commonly known in the art, SLAM is a technique for generating a map of a particular area and determining the position of a vehicle on the concurrently generated map. SLAM techniques play a crucial role in autonomously navigating and mapping unknown environments, finding applications in robotics, augmented reality, and autonomous vehicles.

Concurrently, the advent of crowdsourced maps has transformed the landscape of digital cartography. Crowdsourcing leverages the collective real-time data of users to create and update maps, which reduces the logistical cost incurred by an entity that oversees the map generation process. This collaborative approach enhances the accuracy and relevance of maps, catering to the evolving needs of users. The combination of SLAM techniques and crowdsourced maps offers the potential to create more detailed, up-to-date, and contextually relevant spatial representations.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

A system for generating a map of a paved surface for a vehicle and localizing the vehicle on the map of the paved surface includes an imaging sensor, a vehicle odometry sensor, a memory, a processor, and a transceiver. The imaging sensor captures a series of image frames. The vehicle odometry sensor measures an orientation, velocity, and acceleration of the vehicle. The memory stores a mapping engine as computer readable code. The processor executes the mapping engine to generate a map. The transceiver uploads the map to a server such that the map is accessed by a second vehicle that uses the map to traverse the external environment.

A method for generating a map of a paved surface for a vehicle and localizing the vehicle on the map includes capturing a series of image frames of an external environment of the vehicle. The method further includes measuring an orientation, velocity, and/or acceleration of the vehicle. In addition, the method includes storing a mapping engine on a memory that receives the series of image frames from an imaging sensor and determining an identity and a location of a feature within a first image frame of the series of image frames. The series of image frames is stitched to each other such that the feature in the first image frame of the series of image frames is located at a same position as the feature in a second image frame. In this way, the stitched series of image frames form a combined image frame with dimensions larger than a single image frame from the series of image frames. Subsequently, a most recently received image frame is stitched to the first image frame when a feature identified in the most recently received image frame was previously identified as the feature in the first image frame, thereby forming a closed loop of the stitched series of image frames and generating a map of the external environment of the vehicle. Finally, the method includes uploading the map to a server such that the map is accessed by a second vehicle that uses the map to traverse the external environment.

Other aspects and advantages of the claimed subject matter will be apparent from the following description and appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility.

FIG. 1 depicts a vehicle traversing an environment in accordance with one or more embodiments disclosed herein.

FIGS. 2A, 2B, and 2C depict a visual representation of a process for generating a map of an external environment of a vehicle in accordance with one or more embodiments disclosed herein.

FIG. 3 depicts a system in accordance with one or more embodiments disclosed herein.

FIG. 4 depicts a flowchart of a system in accordance with one or more embodiments disclosed herein.

FIG. 5 depicts a system in accordance with one or more embodiments disclosed herein.

FIGS. 6A and 6B depict a map before and after implementing a “close the loop” technique in accordance with one or more of embodiments disclosed herein.

FIG. 7 depicts a flowchart of a process for generating a map for a vehicle and localizing the vehicle on the map in accordance with one or more embodiments disclosed herein.

### DETAILED DESCRIPTION

Specific embodiments of the disclosure will now be described in detail with reference to the accompanying figures. In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not intended to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Generally, one or more embodiments of the invention as described herein are directed towards a system for generating a map for a vehicle and localizing the vehicle on the map. The system for generating the map for the vehicle and localizing the vehicle on the map includes at least one imaging sensor, at least one vehicle odometry sensor, a memory, a processor, a transceiver, and a server. In the specific context of parking lots or similar paved surfaces, which may be indoors, outdoors, enclosed, unenclosed, and above or below the surface of the earth, affordable and precise maps may not be available for the mass market. This is because traditional maps are typically created through time-consuming and costly sensor-based land surveys, and, consequently, traditional maps are infrequently updated. It is even more infrequent to pass the map updates from the mapping entity to a particular vehicle, as the vehicle must communicate with the mapping entity to receive the updated map. Crowdsourced maps negate some of these challenges, as the logistical hurdles of creating and updating maps are passed to the user of the vehicle, rather than the manufacturing entity.

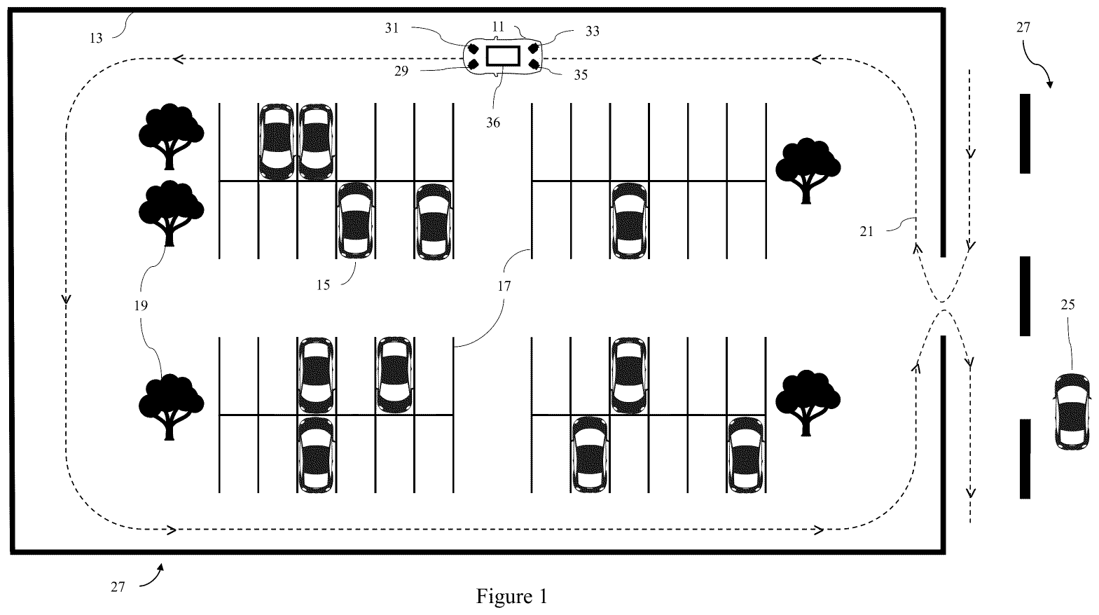

Turning to FIG. 1, FIG. 1 shows a schematic diagram illustrating an example of a paved surface 27 in accordance with one or more embodiments of the invention. Generally, a paved surface 27 is a paved region of land that may be privately owned and maintained by a corporation, or publicly owned and maintained by a governmental authority. The paved surface 27 includes parking lines 17, or painted stripes, that serve to demarcate a location for a user to park or otherwise stop a vehicle's motion for a period of time.

As further shown in FIG. 1, the paved surface 27 is depicted as being a rectangular shape with only one entrance and exit (unnumbered). However, the paved surface 27 may be formed of one or more simple geometric shapes that combine to form an overall complex shape (i.e., a square attached to a rectangle to form an “L” shape to match a strip mall layout), and can include multiple entrances and exits. In addition, the paved surface 27 can contain a plurality of features disposed in an external environment of the vehicle, which are further discussed below.

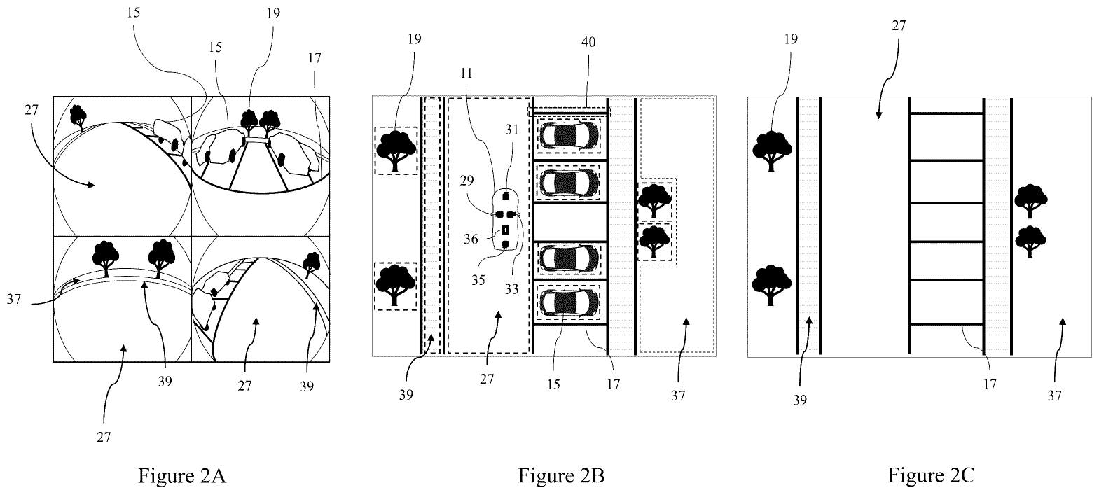

Features disposed in the external environment of the vehicle 11 include parked vehicles 15, parking lines 17, trees 19, traffic signs (not shown), pillars (not shown), sidewalks (e.g., FIG. 2B), and grass (e.g., FIG. 2B), for example. As discussed above, the parking lines 17 are lines painted onto the paved surface 27 to denote a location for temporarily stopping a vehicle. Parking lines 17 may denote additional features as is commonly known in the art, such as an emergency vehicle lane or driving lanes for example. The parked vehicles 15 have been parked by other users in parking slots formed by the parking lines 17, such that the parked vehicles 15 form temporary barriers that the vehicle 11 must avoid. Similarly, trees 19 represent local flora that provides an aesthetically pleasing view to a driver of the vehicle 11, and also forms impediments in the path of travel of the vehicle 11. On the other hand, traffic vehicles 25 are vehicles that pass by, enter, traverse, and/or exit the paved surface 27.

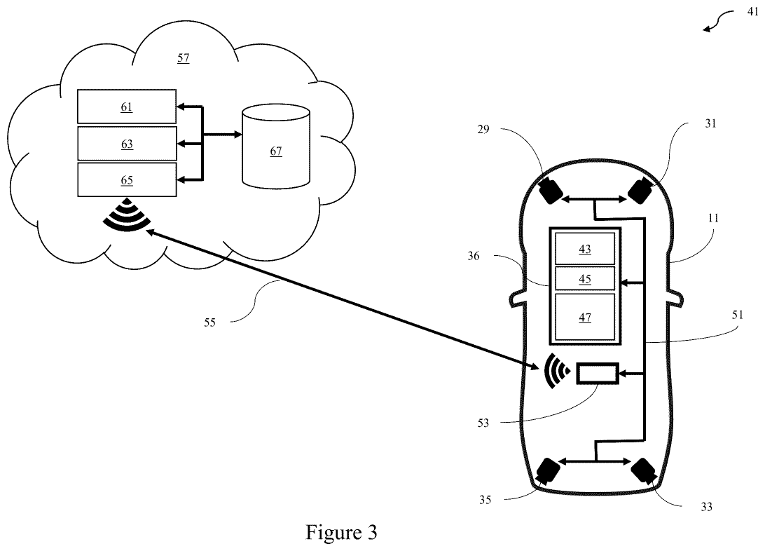

The process of mapping the paved surface 27 is initiated by the vehicle 11 entering the paved surface 27. The vehicle path 21, which is depicted as a dotted line with arrows, shows the that the vehicle 11 enters the paved surface 27 from the paved surface 27, follows the inside perimeter of the paved surface boundary 13, and exits the paved surface 27 to return to the paved surface 27. The vehicle path 21 is included for illustrative purposes to show a hypothetical vehicle path 21 of the vehicle 11, and is not actually painted on the paved surface 27. While the vehicle 11 follows the vehicle path 21 on the paved surface 27, a series of image frames that include a view comprising features disposed in an external environment of the vehicle 11 are collected by a first camera 29, a second camera 31, a third camera 33, and a fourth camera 35. The cameras 29-35 are discussed in further detail in relation to FIG. 3, below. The features disposed in the external environment of the vehicle 11 can comprise, but are not limited to, parking lines 17, traffic signs (not shown), pillars (not shown), parked vehicles 15, sidewalks (e.g., FIG. 2B), grass (e.g., FIG. 2B), and trees 19. At the same time as the series of image frames are collected, odometry information related to an orientation, velocity, and/or acceleration of the vehicle 11 is also collected by odometry sensors 36. The odometry sensors 36 are explained in further detail in relation to FIG. 3, below.

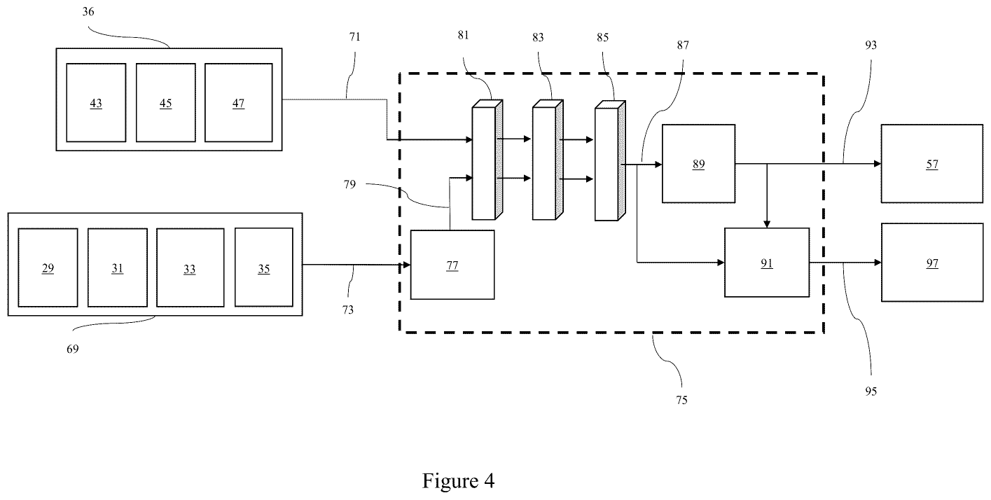

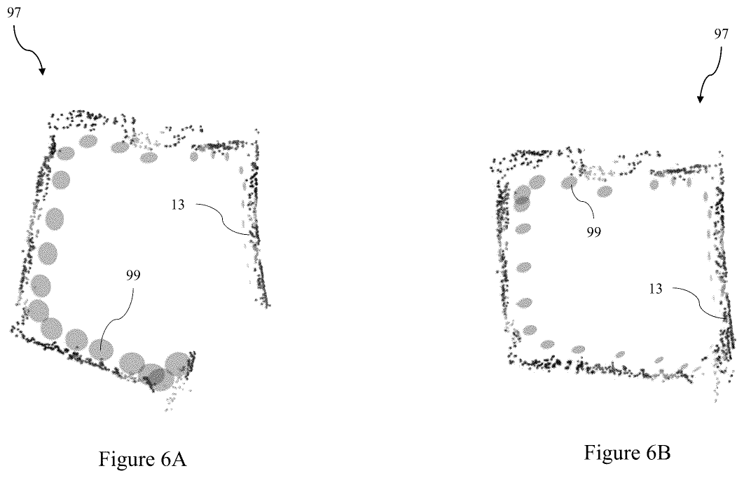

By the use of a mapping engine (e.g., FIG. 4), which will be described in further detail below, the series of image frames and odometry information of the vehicle 11 are transformed into a map (e.g., FIGS. 6A and 6B) of the paved surface 27. The mapping process includes removing dynamic features, such as a second vehicle that is not the user vehicle 11 currently performing the mapping of the paved surface 27, from the map with the use of the mapping engine (e.g., FIG. 4). The mapping engine (e.g., FIG. 4), further removes stationary features that are not permanent features of the paved surface 27, such as parked vehicles 15 or traffic cones (not shown). Permanent features of the paved surface 27 may include, for example, trees 19, grass (e.g., FIG. 2B), sidewalks (e.g., FIG. 2B), parking lines 17, pillars (not shown), and traffic signs (not shown), and the phrase “permanent” refers to concept that these objects cannot be removed from the external environment without egregious effort. Permanent features, temporary features, and dynamic features are identified by the mapping engine (e.g., FIG. 4) through sematic feature-based object detection, which includes identifying and categorizing features in visual data by analyzing their distinctive attributes, and provides precise recognition of features within the environment.

When the vehicle 11 returns to the location where the vehicle 11 initially entered the paved surface 27, the mapping engine (e.g., FIG. 4) recognizes, through semantic feature-based object detection, that the vehicle 11 performed a loop of the paved surface 27, and thereby forms a closed loop of the stitched series of image frames. Additional post processing may be completed on the map, which completes the map generation process. In addition, while a map (e.g., FIGS. 6A and 6B) is being generated or has been made available, the collected series of image frames and odometry information are input to a localization algorithm (e.g., FIG. 4) configured to localize the vehicle 11 on the map.

Turning to FIGS. 2A, 2B, and 2C, these Figures depict a visual representation of a process for generating a map of a paved surface 27. FIG. 2A shows an example embodiment of four views of an external environment of the vehicle 11 captured by the cameras 29-35, while FIG. 2B shows an example of the four views converted into an Inverse Perspective Mapping (IPM) image with annotated features marked by bounding boxes 40, and FIG. 2C shows the resultant map created from the annotated IPM image of FIG. 2B. As shown in FIG. 2A, four views of the external environment of the vehicle 11 are captured by the cameras 29-35 while the vehicle 11 is disposed on the paved surface 27. The views are distorted, which represent images captured by a fish-eye lens that may be utilized by the cameras 29-35 in order to capture a broad view of the surrounding environment. The upper left view depicts a front view of the vehicle 11, the upper right view depicts a right-side view of the vehicle 11, the lower right view depicts a rear view of the vehicle 11, and the lower left view depicts a left-side view of the vehicle 11. As depicted in FIG. 2A, parked vehicles 15 and parking lines 17 are disposed to the right of the vehicle 11, and the paved surface 27 extends in front and behind of the vehicle 11. Further, a grass 37 area is disposed to the left of the vehicle 11, and multiple trees 19 are disposed on the grass 37 areas on both the left and right sides of the vehicle 11. Finally, a sidewalk 39 is present between the transition of the paved surface 27 and the grass 37.

Turning to FIG. 2B, FIG. 2B depicts an annotated IPM image of a bird's eye view perspective generated from the four distorted views of the external environment of the vehicle 11 depicted in FIG. 2A. The IPM image is obtained by the mapping engine (e.g., FIG. 4), and an overview of this process is briefly presented as follows. First, the mapping engine (e.g., FIG. 4) identifies vanishing points in the distorted views, using algorithms such as Random Sample Consensus (RANSAC), Hough transform, and Radon transform, by analyzing the orientation and convergence of lines present in the views. After identifying the vanishing points, a homography transformation is applied in order to map the image from its original distorted perspective to the desired overhead perspective. The homography transformation maps points from one perspective to another without changing straight lines, using algorithms such as Direct Linear Transform (DLT) and RANSAC. Finally, to enhance the visual quality of the transformed image and as part of post processing, interpolation methods fill in any missing data from the transformed image, and smoothing methods reduce high-frequency noise in the image to present a cleaner appearance of the transformed image. Interpolation methods include nearest-neighbor interpolation, bilinear interpolation, and bicubic interpolation, while smoothing methods include Gaussian smoothing, median filtering, and mean filtering. Additional adjustments can be made as desired to fine-tune parameters such as the angle of view and distortion correction.

The mapping engine (e.g. FIG. 4), can identify the features present in the IPM image using semantic feature based object detection as discussed above. The features are annotated with bounding boxes 40, as depicted in FIG. 2B. For the sake of preventing the FIG. 2B from being illegible, bounding boxes 40 are not present for every feature in the embodiment, however it is to be understood that bounding boxes 40 are present for multiple features in the external environment of the vehicle 11, and are not limited to the examples provided herein. Bounding boxes 40 enclose a feature in the external environment of the vehicle 11 and represent individual features identified by an object detection algorithm employed by the mapping engine (e.g., FIG. 4). As can be seen in the current embodiment, the bounding boxes 40 enclose the trees 19, the sidewalk 39, the parked vehicles 15, the parking lines 17, the paved surface 27, and the grass 37.

Turning to FIG. 2C, FIG. 2C depicts a map of the external environment of the vehicle. In FIG. 2C, the bounding boxes 40 from the annotated IPM image of FIG. 2B have been removed, and the identity of the objects is stored as metadata of the map. Thus, FIG. 2C depicts one embodiment of the map generated by the vehicle 11 at the conclusion of the mapping process. As is further shown in FIG. 2C, the map does not include any temporary features and/or dynamic features from the previous FIG. 2B, as these objects have been removed by the mapping engine (e.g., FIG. 4). For example, the parked vehicles 15 are identified by the mapping engine (e.g., FIG. 4) as being a temporary feature, and have been removed from the map of FIG. 2C as a consequence. The identities of temporary objects and permanent objects may be stored in the mapping engine (e.g., FIG. 4) in the form of a lookup table (not shown), such that the vehicle 11 may search the lookup table for the identity of the object, and accurately determine whether the object is considered permanent or temporary.

Turning to FIG. 3, FIG. 3 shows an example of a system 41 in accordance with one or more embodiments disclosed herein. As depicted in FIG. 3, the system 41 includes a vehicle 11 and a server 57. The vehicle 11 may be a passenger car, a bus, or any other type of vehicle 11. As shown in FIG. 3, a vehicle 11 includes a first camera 29, a second camera 31, a third camera 33, and a fourth camera 35, which serve to capture images in the local environment of the vehicle 11 as discussed above. The vehicle 11 further includes an Electronic Control Unit (ECU) 53 that stores a mapping engine (e.g., FIG. 4) that is operatively connected to the various other components of the vehicle 11 discussed herein. In addition, the vehicle 11 includes at least one vehicle odometry sensor 36, which may be a global positioning system (GPS) unit 43, an inertial measurement unit (IMU) 45, and/or a wheel encoder 47. As is commonly known in the art, a GPS unit 43 communicates with a satellite to triangulate a user's position, while an IMU 45 is functionally embodied as an accelerometer and the wheel encoder 47 may include one or more hall effect sensors, for example. Components of the vehicle 11 are communicatively coupled by way of a data bus 51, which is formed as a series of wires attached to wiring harnesses that individually connect to and interface with their respective component.

The first camera 29, second camera 31, third camera 33, and fourth camera 35 are imaging sensors (e.g., FIG. 4) depicted as cameras. The cameras may alternatively be embodied as Light Detection and Ranging (LiDAR) sensors, radar sensors, ultrasonic sensors, or infrared sensors without departing from the nature of the specification. Additionally, embodiments of the vehicle 11 are not limited to including only four cameras, and may include more or less cameras based on budgeting, design, or longevity constraints. The cameras 29-35 are configured to capture a series of image frames that include a view of features disposed in an external environment of the vehicle 11. The features disposed in an external environment of the vehicle 11, as previously discussed with regard to FIGS. 1-2C, may include, but are not limited to, parking lines 17, traffic signs (not shown), pillars (not shown), parked vehicles 15, sidewalks 39, grass 37, and trees 19. Further, the cameras 29-35 may capture the series of images in the visible light and/or infrared light wavelengths, and the mapping capabilities of the vehicle 11 are not limited in this regard.

Additionally, the vehicle 11 further includes at least one vehicle odometry sensor 36 configured to determine odometry information related to an orientation, velocity, and/or acceleration of the vehicle. The odometry sensors 36 present in the current embodiment include a GPS unit 43, an IMU 45, and a wheel encoder 47. The odometry sensors 36 are configured to gather odometry information associated with the movements of the vehicle 11 through the external environment. The GPS unit 43 provides a GPS position of the vehicle 11, using satellite signal triangulation, that can be associated with the map. In addition, the GPS position of the vehicle 11 is associated with the map when the map is uploaded to the server 57 in the form of a lookup table, such that a lookup function is used to download a particular map corresponding to the geographical location of the vehicle 11.

Therefore, the server 57 itself includes a global map (e.g., FIG. 4) separated into a plurality of local maps of varying sizes organized based upon the GPS positions of the vehicles 11 that upload maps to the server 57. To limit the amount of data downloaded by a user, the GPS position of the vehicle 11 is used by the server 57 to determine where in the world the user is located. Additionally, the user can choose how much map data to download, ranging from levels of the world, a continent, a country, a state or province, a city, or a particular paved surface 27. Once a user has selected a particular tile size (i.e., an amount of map data to download) a lookup function is used by the server 57 to download a particular map tile based on a user's current GPS position.

On the other hand, the IMU 45 and the wheel encoder 47 are configured to facilitate the collection of angular movement data related to the vehicle 11. The IMU 45 utilizes accelerometers and gyroscopes to measure changes in velocity and orientation of the vehicle 11, which provides a real-time acceleration and angular velocity of the vehicle 11. The wheel encoder 47, disposed on the main drive shaft or individual wheels of the vehicle 11, measures rotations through a Hall Effect sensor, and converts the rotation of the wheels into the distance traveled by the vehicle 11 and velocity of the vehicle 11. When the GPS unit 43, IMU 45, and wheel encoder 47 data are combined, the system 41 becomes capable of determining the Real Time Kinematic (RTK) positioning of the vehicle 11, such that the mapping process is capable of achieving up to 1 centimeter accuracy of the position of the vehicle 11 on the map. If the GPS unit 43 is unable to establish an uplink signal with the satellite, such as when the vehicle 11 is in an underground paved surface 27, the vehicle 11 is still capable of generating a map of the external environment using the remaining hardware of the vehicle 11 (e.g., the cameras 29-35, the odometry sensors 36, and additional components discussed below).

Thus, as a whole, the odometry sensors 36 serve to provide orientation data related to the position of the vehicle 11 in the external environment. In conjunction with the imaging sensors (e.g., cameras 29-35), the mapping engine (e.g., FIG. 4) is capable of determining the identity and real-world location of the features within the series of image frames, and a map (e.g., FIGS. 6A and 6B) can be generated. That is, by way of a semantic feature based deep learning model, the mapping engine (e.g., FIG. 4) is capable of detecting the identity of features. By associating the local position of the vehicle 11 (captured by the IMU 45 and wheel encoder 47) with the feature's identity, the mapping engine (e.g., FIG. 4) is capable of populating a digital map (e.g., FIGS. 6A and 6B) with the features.

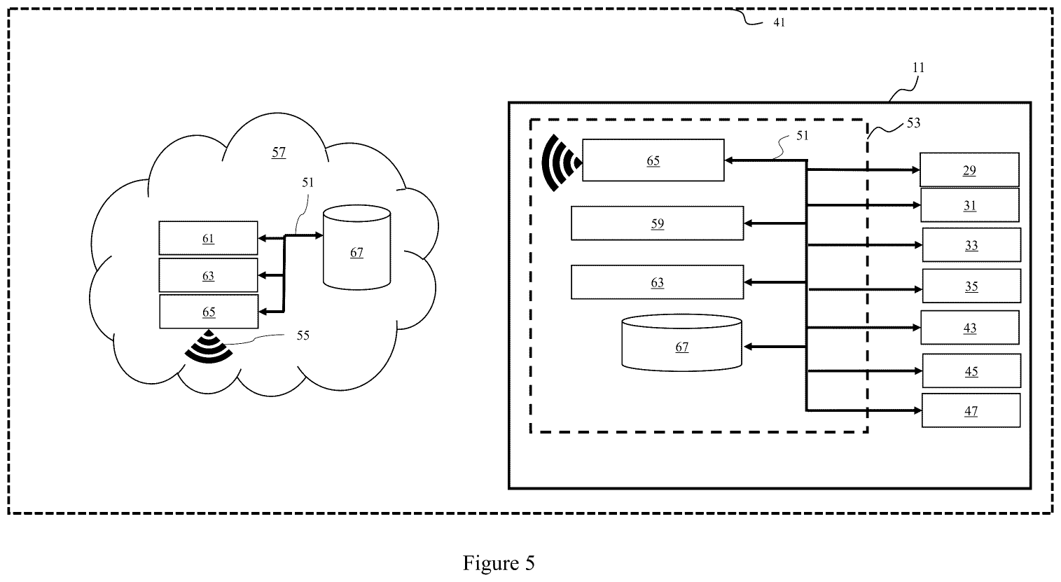

The ECU 53 of the vehicle 11 is further detailed in relation to FIG. 5, and generally includes one or more processors (e.g., FIG. 5), integrated circuits, microprocessors, or equivalent computing structures that are further coupled to a transceiver (e.g., FIG. 5). The ECU 53 is thus configured to execute a series of instructions, formed as computer readable code, that causes the ECU 53 to receive (by way of the data bus 51) and interpret the odometry information and the series of image frames from the odometry sensors 36 and the cameras 29-35. A memory (e.g., FIG. 5) of the vehicle 11, formed as a non-transient storage medium, is configured to store the mapping engine (e.g., FIG. 4) as computer readable code. The computer readable code, may, for example, be written in a language such as C++, C#, Java, MATLAB, or equivalent computing languages suitable for simultaneous localization and mapping of a vehicle 11 in an external environment. Through the use of the memory (e.g., FIG. 5), a processor (e.g., FIG. 5), a transceiver (e.g., FIG. 5), and a data bus 51, the ECU 53 is configured to receive the odometry information from the odometry sensors 36 and the series of image frames from the cameras 29-35, generate a map and localize the vehicle 11 on the map, and transmit the map to a server 57. The process of generating a map is further detailed in relation to FIG. 4, below.

In order to share data between the vehicle 11 and the server 57, the vehicle 11 and the server 57 both include a transceiver 65 configured to receive and transmit data. As described herein, a “transceiver” refers to a device that performs both data transmission and data reception processes, such that the transceiver 65 encompasses the functions of a transmitter and a receiver in a single package. In this way, the transceiver 65 includes an antenna (such as a monitoring photodiode), and a light source such as an LED, for example. Alternatively, the transceiver 65 may be split into a transmitter and receiver, where the receiver serves to receive a map from the vehicle 11, and the transmitter serves to transmit map data hosted on the server 57 to the vehicle 11. In this way, the vehicle 11 can transmit a map (e.g., FIGS. 6A and 6B) to the server 57, and the server 57 can transmit map data hosted on the server 57 to the vehicle 11. Other vehicles (not shown) equipped with an ECU 53 as described herein are also capable of accessing maps stored on the server 57, such that the server 57 acts as a mapping “hub” or database for a fleet of vehicles to upload and receive maps therefrom.

With regard to the vehicle 11 transmitting data, data is transmitted from the ECU 53 of the vehicle 11 by way of a transceiver (e.g., FIG. 5) that forms a wireless data connection 55 with the server 57. To this end, the wireless data connection 55 may be embodied as a cellular data connection (e.g., 4G, 4G LTE, 5G, and contemplated future cellular data connections such as 6G). Alternatively, the wireless data connection 55 may include forms of data transmission including Bluetooth, Wi-Fi, Wi-Max, Vehicle-to-Vehicle (V2V), Vehicle-to-Everything (V2X), satellite data transmission, or equivalent data transmission protocols. During a data transmission process, the transceiver (e.g., FIG. 5) of the vehicle 11 is configured to upload a map (e.g., FIGS. 6A and 6B) to the server 57 such that the map is subsequently accessed by a second vehicle (not shown) that uses the map to traverse the external environment.

Continuing with FIG. 3, the server 57, as previously discussed, includes a transceiver 65 configured to receive a map from the ECU 53 of the vehicle 11 as well as transmit previously generated map data hosted on the server 57 to the vehicle 11. In addition, the server 57 includes a memory 67, a Graphics Processing Unit (GPU) 61, and a Central Processing Unit (CPU) 63. Collectively, the GPU 61 and the CPU 63 serve to execute the computer-readable code forming the mapping engine (e.g., FIG. 4). As is commonly known in the art, a GPU 61 performs parallel processing, and is particularly advantageous for the repetitive nature of image analysis and object detection. On the other hand, the CPU 63 is configured to perform tasks at a much faster rate than a corresponding GPU 61, but is limited to performing a single function at a time. Thus, the combination of the GPU 61 and the CPU 63 is beneficial for executing the mapping engine (e.g., FIG. 4), as image processing functions may be performed by the GPU 61 and mathematical processing operations (e.g., vehicle and/or image odometry calculations) may be performed with the CPU 63. The vehicle 11 may also include a GPU 61 for object detection purposes, but such is not necessary depending on various logistical considerations. For its part, the memory 67 includes a non-transient storage medium, such as flash memory, Random Access Memory (RAM), a Hard Disk Drive (HDD), a solid state drive (SSD), a combination thereof, or equivalent. The memory 67 is connected to the GPU 61 and the CPU 63 by way of a data bus 51, which is a collection of wires and wiring harnesses that serve to transmit electrical signals between these components.

Detailed examples of a mapping engine (e.g., FIG. 4), which is one of the foremost components involved in interpreting and processing data in the system 41, are further described below in relation to FIG. 4. Functionally, the mapping engine (e.g., FIG. 4) generally includes a deep learning neural network that generates a map and simultaneously localizes the vehicle 11 on the map using a Simultaneous Localization and Mapping (SLAM) algorithm. The instructions for the mapping engine (e.g., FIG. 4) are stored on the memory of the vehicle 11 (e.g., FIG. 5) and/or on the memory 67 of the server 57. In the case of running locally on the vehicle 11, the processing is performed by the processor (e.g., FIG. 5); otherwise, processing is completed by the GPU 61 and the CPU 63 as discussed above. Similarly, in a distributed computing environment the map is transmitted via the transceiver of the vehicle 11 (e.g., FIG. 5) to the server 57.

Turning to FIG. 4, FIG. 4 shows a mapping engine 75 used to generate a map of an external environment of a vehicle 11 and localize the vehicle 11 on the map. Consistent with the description of FIG. 2B, the mapping engine 75 may operate on or in conjunction with devices of both the server 57 and the vehicle 11.

As discussed previously in relation to FIG. 3, the mapping engine 75 receives multiple forms of data as its input, which provides the mapping engine 75 with a holistic view of the external environment of the vehicle 11. The multiple forms of data are represented in FIG. 3 as odometry data 71 and image data 73. The odometry data 71 is captured by odometry sensors 36 such as a GPS unit 43, an IMU 45, and a wheel encoder 47. For its part, the odometry data 71 includes the previously discussed movement data related to an orientation, and/or velocity, and/and/or acceleration of the vehicle 11.

On the other hand, the plurality of imaging sensors 69 output image data 73, where the image data 73 includes the previously discussed series of image frames captured by a first camera 29, a second camera 31, a third camera 33, and a fourth camera 35 (i.e., imaging sensors 69). The imaging sensors 69 are configured to capture a series of image frames that include a view including features disposed in an external environment of the vehicle 11. Further, as previously discussed, the plurality of imaging sensors 69 are not limited to only four cameras, but may include one or more of Light Detection and Ranging (LiDAR) sensors, radar sensors, ultrasonic sensors, infrared sensors, or any combination thereof. The image data 73 captured by the plurality of imaging sensors 69 includes information regarding physical features located in the external environment of the vehicle 11, such as the color, size, and orientation thereof. As previously discussed in relation to FIG. 1, the features located in the external environment of the vehicle 11 may include, but are not limited to, parking lines 17, traffic signs (not shown), pillars (not shown), parked vehicles 15, sidewalks 39, grass 37, and trees 19.

The plurality of imaging sensors 69 capture a plurality of image frames that include the series of image frames and are input as image data 73 into the mapping engine 75. The mapping engine 75 includes a perspective mapping algorithm 77, such as BirdEye or Fast Inverse Perspective Mapping Algorithm (FIPMA), for example, that generates an Inverse Perspective Mapping (IPM) image 79 from the image data 73, which includes the plurality of image frames. Because there are a plurality of image frames, the IPM image 79 generated through the perspective mapping algorithm 77 provides a unified and distortion-corrected view of the external environment of the vehicle 11. This distortion correction significantly improves the accuracy of subsequent feature detection, ensuring reliable identification and tracking of features across the transformed image data 73.

The IPM image 79 is then input into a semantic feature-based deep learning neural network configured to determine and identify a location of the features within each IPM image 79. The semantic feature-based deep learning neural network is formed by an input layer 81, one or more hidden layers 83, and an output layer 85. The input layer 81 serves as an initial layer for the reception of the odometry data 71 and the series of IPM Images 79. The one or more hidden layers 83 includes layers such as convolution and pooling layers, which are further discussed below. The number of convolution layers and pooling layers of the hidden layers 83 depend upon the specific network architecture and the algorithms employed by the semantic feature-based deep learning neural network, as well as the number and type of features that the network is configured to detect. For example, a neural network flexibly configured to detect multiple types of features will generally have more layers than a neural network configured to detect a single feature. Thus, the specific structure of the layers 81-85, including the number of hidden layers 83, is determined by a developer of the mapping engine 75 and/or the system 41 as a whole.

In general, a convolution filter convolves the input series of IPM Images 79 with learnable filters, extracting low-level features such as the outline of features and the color of features. Subsequent layers aggregate these features, forming higher-level representations that encode more complex patterns and textures associated with the features. Through training, the neural network refines weighted values associated with determining different types of features in order to recognize semantically relevant features for different classes of features. The final layers of the convolution operation employ the learned features to make predictions about the identity and location of the features.

On the other hand, a pooling layer reduces the dimension of outputs of the convolution layer into a down-sampled feature map. For example, if the output of the convolution layer is a feature map with dimensions of 4 rows by 4 columns, the pooling layer may down sample the feature map to have dimensions of 2 rows by 2 columns, where each cell of the down sampled feature map corresponds to 4 cells of the non-down sampled feature map produced by the convolution layer. The down sampled feature map allows the feature extraction algorithms to pinpoint the general location of various objects detected with the convolution layer and filter. Continuing with the example provided above, an upper left cell of a 2×2 down-sampled feature map will correspond to a collection of 4 cells occupying the upper left corner of the feature map. This reduces the dimensionality of the inputs to the semantic feature-based deep learning neural network formed by the layers 81-85, such that an image including multiple pixels can be reduced to a single output of the location of a specific feature within the image.

In the context of the various embodiments described herein, a feature map may reflect the location of various physical objects present on a paved surface 27, such as the locations of parking lines 17 and trees 19. Subsequently, the feature map is converted by the hidden layer 83 into bounding boxes 40 that are superimposed on the input image, or IPM image 79, to denote the location of various features identified by the feature map. This annotated IPM image 79 is sent to the output layer 85, and is output to the remainder of the mapping engine 75 as the annotated image frame 87.

In the case that a dynamic feature is captured in an IPM image 79 and detected by the semantic feature based neural network, the mapping engine 75 is configured to remove the dynamic feature from the map. A feature is determined to be dynamic when it is identified as being in a different location than in a previous IPM image 79. For example, a traveling (i.e., dynamic) traffic vehicle 25 may appear in a first image as being located in front of the vehicle 11, and appear behind the vehicle 11 in a second IPM image 79, indicating that the traveling vehicle has passed the vehicle 11 in an opposite direction. Additionally, features which are determined as stationary, or in the same location in all IPM Images 79, are further categorized into two categories: permanent and temporary. For example, temporary features include parked vehicles 15 and traffic cones (not shown), as they are not a fixed structure or element of the external environment and will eventually be removed from the external environment. Permanent features include parking lines 17, sidewalks 39, grass 37, and trees 19, for example, as these features are considered to be part of the external environment and fixed in their respective locations. The mapping engine 75 stores the identities and locations of the dynamic, temporary, and permanent features in a lookup table on the memory 67, which allows the mapping engine 75 to populate the map with only the permanent features and discard the temporary and dynamic features.

After the features disposed in the external environment of the vehicle 11 are identified by the semantic feature-based deep learning neural network, the annotated image frame 87 is input into a stitching sub-engine 89. The stitching sub-engine 89 stitches, or concatenates, the series of annotated image frame 87 to each other such that a feature in the first annotated image frame 87 of the series of annotated image frame 87 is located at the same position as a feature in a second annotated image frame 87 that has the same identity. In this way, the stitched annotated image frames 87 form a combined image frame with dimensions larger than a single annotated image frame 87.

At the end of the image stitching process, the stitching sub-engine 89 stitches an immediately received annotated image frame 87 to the first annotated image frame 87. The stitching process may be feature based, odometry based, or a combination thereof. For feature based stitching, the stitching sub-engine 89 will stitch the image frames 87 when a feature identified in the most recently received annotated image frame 87 was previously identified as the feature in the first annotated image frame 87 to form a closed loop of stitched annotated image frames 87. Alternatively, for odometry based stitching, the stitching sub-engine 89 recognizes that the vehicle 11 has traveled in a loop by way of the odometry data 71, which is further discussed below.

Specifically, the mapping engine 75 will be aware of the formation of a “loop” on the basis of a plurality of odometry metrics. In the case that the vehicle 11 is in communication with a GPS satellite, the stitching sub-engine 89 of the mapping engine 75 recognizes that the vehicle 11 has completed a loop when the GPS coordinates of the vehicle 11 are the same, or substantially similar to, a GPS coordinate received during a previous period of time. In this case, the “substantially similar GPS coordinates” are coordinates that are within a specified distance (e.g., 3 feet or ˜0.91 meters), to account for minor variations in the travel path of the vehicle. Similarly, the previous period of time may be a short period of time, such as less than 15 minutes, for example, during which the vehicle 11 is assumed to be attempting to traverse the paved surface 27.

Alternatively, in offline use cases, the stitching sub-engine 89 of the mapping engine 75 may determine that the vehicle 11 has completed a loop when the odometry data 71 implies a looped travel path. For example, the stitching sub-engine 89 may determine that the vehicle 11 has traveled a measured distance in a certain direction, turned 90 degrees, traveled an additional measured distance, and so on until the vehicle 11 has returned to its original position. Upon returning to its original position, the odometry data 71 will naturally have a “mirrored” format, where the vehicle 11 has undone any positive or negative travel in one or more directions to return to its original position. This can be mathematically determined by the mapping engine 75 by performing a vectorized addition of the odometry information, and the mapping engine 75 is aware that the vehicle 11 has returned to a previous location if its movements sum to zero, or substantially zero. Thus, by analyzing the odometry data 71 to determine the net position of the vehicle 11, the stitching sub-engine 89 is capable of determining that the vehicle 11 has returned to its original position, and thus that the vehicle 11 has completed a loop.

Once the stitching sub-engine 89 has determined that the vehicle 11 has traveled a closed loop of the external environment on the paved surface 27, the stitching sub-engine 89 stitches the images captured by the vehicle 11 at timestamps of the initial and final loop positions. In this way, the stitched series of images forms a map of a loop circumnavigating part or all of the paved surface 27, where the stitched image has dimensions larger than its constituent images.

As previously discussed, a transceiver 65 is configured to upload the map to the server 57 such that the map may be accessed by a second vehicle that can use the map to traverse the external environment. The map output by the mapping engine 75 and uploaded to the server 57 is called a global map 93, as this map is merged with other maps, created by other vehicles, to form a coalesced map formed of a plurality of individual maps. The global map 93 is periodically updated as vehicles download and use portions of the global map 93 as local maps 97. More specifically, the global map 93 is updated by removing features from the map that were previously detected by a first vehicle and are no longer present in the external environment when traversed by a second vehicle, such that the second vehicle does not detect the features previously detected by the first vehicle. For example, when a paved surface 27 undergoes construction or new parking lines 17 are painted, a second vehicle will be unable to detect the parking lines 17 of the map generated by a first vehicle. In this case, a new map will be generated without the parking lines 17, and the currently existing map in the server 57 will be replaced with the newly generated map. However, to prevent cases where the map is incorrectly updated, the server 57 may be configured to only allow a map to be updated if the vehicle's temperature is above a certain threshold, or if the annotated images reflect poor weather conditions (e.g., snow, rain, fallen leaves, etc.).

In this way, the global map 93 is periodically updated, and other vehicles may use portions of the global map 93 (i.e., local maps 97) to determine their position during a localization process. The localization process is described below in relation to the vehicle 11 for clarity, but may be applicable to any vehicle capable of interpreting a feature rich semantic map. In general, a vehicle 11 is localized on a local map 97 by way of a localization algorithm 91, which is typically executed onboard the vehicle 11 by the ECU 53. Initially, the localization algorithm 91 generates candidate positions of the vehicle 11 on the local map 97 based upon the odometry data 71 and the series of annotated image frame 87. The number of candidate positions varies as a function of the overall system 41 design, but is generally a function of the processing capabilities of the ECU 53 and its constituent hardware, and/or the hardware of the server 57. Each candidate position is assigned a correspondence score that represents a correlation between the odometry data 71, the series of annotated image frame 87, and the features disposed in the external environment of the vehicle 11 adjacent to the candidate position. Once the candidate scores are calculated, the vehicle 11 is determined (by the ECU 53) to be located at a particular candidate position having a highest correspondence score. This process may be repeated in an iterative fashion in order to determine the position of the vehicle 11 quickly and accurately in a real-time fashion. Consistent with the above, the localization algorithm 91 may be embodied by an algorithm such as an Iterative Closest Point (ICP) algorithm, Random Sample Consensus (RANSAC) algorithm, bundle adjustment algorithm, or Scale-Invariant Feature Transform (SIFT) algorithm.

In addition, the localization algorithm 91 is further configured to determine a 6 Degrees of Freedom (6-DoF) localized position 95 of the vehicle 11, which represents the pose of the vehicle 11 in relation to 6 degrees of freedom: X, Y, Z, yaw, pitch, and roll. On a flat, level surface of the Earth (i.e., the paved surface 27), the X-axis is the direction of vehicle 11 travel. The Y-axis is defined as perpendicular to the X-axis but parallel to the surface of the Earth. Thus, the Z-axis extends normal to the surface of the Earth. Similarly, pitch refers to a rotation about the X-axis, while roll and yaw refer to a rotation about the Y-axis and Z-axis, respectively. The 6-DoF localized position 95 of the vehicle 11 is determined by the use of an extended Kalman filter, which has inputs of the odometry data 71 and the image data 73 captured by the odometry sensors 36 and the imaging sensors 69. Functionally, the extended Kalman filter integrates the odometry data 71 and the image data 73 with a nonlinear system model to provide accurate and real-time estimates of the 6-DoF localized position 95 of the vehicle. In particular, the extended Kalman filter couples a state space model of the current motion of the vehicle 11 with an observation model of the predicted motion of the vehicle 11, and predicts the subsequent localized position of the vehicle 11 in the previously mentioned 6-DoF.

After the 6-DoF localized position 95 of the vehicle 11 is determined by the extended Kalman filter executed by the localization algorithm 91, the vehicle 11 is considered to be fully localized on the local map 97. The localization process allows the vehicle 11 to utilize generated local maps 97 in the real-world, such that a first vehicle 11 may download and use a local map 97 of a paved surface 27 that the first vehicle 11 has never traversed but has been mapped by a second vehicle (not shown). This also allows the global map 93 to be updated with remote or rarely traversed areas, as a vehicle 11 only needs to travel in a single loop to generate a map of a paved surface 27. Such is advantageous, for example, in areas such as parking lots that are publicly accessible but privately owned by a business entity, as these areas are rarely mapped by typical mapping entities by are often traversed by consumers.

Turning to FIG. 5, FIG. 5 presents a detailed overview of the physical hardware used in the system 41. As shown in FIG. 5, a server 57 is wirelessly connected to a vehicle 11 via transceivers 65. More specifically, the transceivers 65 belonging to the server 57 and the vehicle 11 include components such as photodiodes and photoreceptors, or oscillatory transmission and reception coils that transmit data signals therebetween. The data signals may, for example, be transmitted according to wireless signal transmission protocols, such that the transceivers 65 transmit Wi-Fi, Bluetooth, Wi-Max, or other signals of various forms as described herein. In this way, the transceivers 65 form a wireless data connection 55 that allows for the various data described herein to be transmitted between the server 57 and the vehicle 11.

In addition to the transceiver 65, the vehicle 11 includes a processor 59, whereas the server 57 includes a CPU 63 and a GPU 61 as discussed in relation to FIG. 3. As noted above, the processor 59 may be formed as a series of microprocessors, an integrated circuit, or associated computing devices that serve to execute instructions presented thereto. Similarly, the vehicle 11 and the server 57 include a memory 67. The memory 67 is formed as a non-transient storage medium such as flash memory, Random Access Memory (RAM), a Hard Disk Drive (HDD), a solid state drive (SSD), a combination thereof, or equivalent devices. The memory 67 of the vehicle 11 and the memory 67 of the server 57 are configured to store computer instructions for performing any operations associated with the vehicle 11 and the server 57, respectively. As one example, computer readable code forming the mapping engine 75 may be hosted either entirely on the memory 67 of the vehicle 11, or split between a combination of the memory 67 of the server 57 and the memory 67 of the vehicle 11. In either case, the computer readable code forming the mapping engine 75 is executed as a series of instructions by the processor 59 of the server 57 or the vehicle 11 as discussed above. In addition, the memory 67 of the server 57 includes computer code for the memory 67 to transmit and receive data to and from the vehicle 11 via a wireless data connection 55.

Turning to the vehicle 11, the vehicle 11 includes an ECU 53 that is formed, in part, by the transceiver 65, the processor 59, and the memory 67. The ECU 53 is connected to the odometry sensors 36 and the imaging sensors 69 via a data bus 51. The imaging sensors 69 include a first camera 29, a second camera 31, a third camera 33, and a fourth camera 35. The odometry sensors 36 include a GPS unit 43, an IMU 45, and a wheel encoder 47. The imaging sensors 69 are not limited to including only cameras, and may include Light Detection and Ranging (LiDAR) sensors, radar sensors, ultrasonic sensors, infrared sensors, or any other type of imaging sensor 69 interchangeably. Alternate embodiments of the vehicle 11 are not limited to including only four imaging sensors 69, and may include more or less imaging sensors 69 depending on budgeting or vehicle geometry (e.g., the size and shape of the vehicle 11), for example. The imaging sensors 69 serve to capture a series of image frames that include a view of features disposed in an external environment of the vehicle 11.

The odometry sensors 36 of the vehicle 11 capture odometry information related to an orientation, velocity, and/or acceleration of the vehicle 11. More specifically, the GPS unit 43 provides a GPS position of the vehicle 11 that is associated with the map when the map is uploaded to the server 57. The GPS position of the vehicle 11 is associated with the local map 97 when the local map 97 is uploaded to the server 57 to form a portion of the global map 93. Therefore, the server 57 includes a plurality of local maps 97 that forms a global map 93, where the local maps 97 are organized based upon the GPS positions of the vehicles 11 that generate the local maps 97. By way of an infotainment module (not shown) of the vehicle 11, the user can choose how many local maps 97 to download, ranging from levels of an entire continent, an entire country, an entire state or province, or an entire city.

The IMU 45 and the wheel encoder 47 are configured to facilitate the collection of movement, or odometry, data related to the vehicle 11. The odometry information is used to determine the sequencing of IPM images 79, such that each IPM image 79 is associated with a particular location of the vehicle 11. In this way, the stitching sub-engine 89 utilizes information provided by the IMU 45 and the wheel encoder 47 to facilitate a correct spacing of the IPM images 79. Similarly, by utilizing data provided by each of the GPS unit 43, IMU 45, and wheel encoder 47, the ECU 53 is capable of determining the Real Time Kinematic (RTK) positioning of the vehicle 11, such that the mapping process can achieve an accuracy of the position of the vehicle 11 on the map with a 1 centimeter precision.

Turning to FIGS. 6A and 6B, FIG. 6A shows an example embodiment of a local map 97 prior to conducting a close-the-loop technique. In juxtaposition, FIG. 6B shows an example of a local map 97 after implementing the close-the-loop technique. As shown in FIG. 6A, the local map 97 includes a rectangular paved surface boundary 13 and uncertainty bounds 99, which are depicted by way of a machine vision representation generated by the mapping engine 75. The paved surface boundary 13 is depicted as a series of dots, which represents various points at which the mapping engine 75 has detected the paved surface boundary 13. For example, each dot may correspond to a cluster of pixels on an IPM image 79 that corresponds to a curb bordering a paved surface 27 in the real world. For the purpose of depicting the close-the-loop technique without unnecessary detail, FIGS. 6A and 6B do not include features other than the paved surface boundary 13. However, it is understood that actual embodiments of the local map 97 will normally be populated with features such as parking lines 17, sidewalks 39, grass 37, and trees 19 as depicted in FIG. 2C.

The circular uncertainty bounds 99 provide a visual representation of the evolving spatial comprehension of the mapping engine 75. As the uncertainty bounds 99 are estimations of the position of the vehicle 11, these bounds also depict the travel path of the vehicle 11 as the vehicle 11 follows the paved surface boundary 13. The varying sizes of the uncertainty bounds 99 directly correlate with the degree of misalignment at different points in generating the map. Uncertainty bounds 99 with a relatively large diameter have a greater the degree of misalignment, or uncertainty, of the location of the vehicle 11, and vice versa. As can be seen on right most side of the paved surface boundary 13, the uncertainty bounds 99 are relatively small in comparison to the uncertainty bounds 99 located along the bottom most side of the paved surface boundary 13. This implies that the mapping engine 75, and more specifically the localization algorithm 91 thereof, becomes more unsure of the location of the vehicle 11 as the vehicle 11 travels in a counterclockwise direction. Thus, the paved surface boundary 13 of FIG. 6A is misaligned and not connected, as the mapping engine 75 becomes less sure of the location of the vehicle 11 as time progresses.

In general, the misalignment of the paved surface boundary 13 may occur due to variations in the imaging sensor 69 perspective, changes in lighting conditions, and the dynamic nature of the features and environment being captured. Additionally, factors such as occlusions, partial obstructions (i.e., a passing traffic vehicle 25 entering the view including features disposed in the external environment of the vehicle 11), or feature deformations can contribute to misalignment. Other contributing factors include, but are not limited to, hardware vibrations, sensor drift, improper sensor calibration, and/or similar challenges.

To remedy the misalignment of the local map 97, the mapping engine 75 is configured, via the stitching sub-engine 89, to perform a close-the-loop process, the output of which is visually depicted in FIG. 6B. As discussed above, the close-the-loop technique involves stitching an initial image captured by cameras 29-35 to a final image captured thereby, which forms a closed loop local map 97. Thus, FIG. 6B depicts a local map 97 including a connected paved surface boundary 13, such that the first images depicting the paved surface boundary 13 are stitched to the last images captured by the cameras 29-35. In this way, the last images captured by the cameras 29-35 include a same portion of the paved surface boundary 13 as the first images, and the resultant local map 97 has a large cluster of semi-redundant images depicting the paved surface boundary 13 in its lower right-hand corner.

As part of the close-the-loop technique, the mapping engine 75 may further perform post processing to better align corners of the resulting local map 97. For example, the stitching sub-engine 89 may determine, after the local map 97 has been stitched and based on the odometry data 71, that the vehicle 11 has traveled at a 90 degree angle (i.e., taken a right or left hand turn). This may be determined by concluding that the vehicle 11 was traveling in a particular direction, such as the +X direction, and is now traveling in a perpendicular direction, such as the +Y direction. In addition, because the odometry data 71 is stored in the form of a lookup table, the stitching sub-engine 89 may make this determination by comparing a series of odometry values across a relatively short timeframe (e.g., 30 seconds). In the case where the stitching sub-engine 89 determines that the vehicle 11 has turned, the stitching sub-engine 89 aligns the corresponding portion of the local map 97 according to the odometry data 71. By performing the corner alignment in short segments, the stitching sub-engine 89 is capable of performing post-processing on the local map 97 to ensure it represents the real world external environment of the vehicle 11.

In conjunction with performing corner correction, the stitching sub-engine 89 is configured to assign an estimated shape to the local map 97. As a first example, the best estimated guess can be formed by the stitching sub-engine 89 determining that the sides of the paved surface boundary 13 (in FIGS. 6A and 6B) spaced apart by a fixed distance, and substantially similar in size (e.g., within one car length of each other). In this case, the mapping engine 75 concludes that the most reasonable shape for the paved surface 27 is a rectangle and/or square. By way of additional example, the stitching sub-engine 89 may determine that the local map 97 should have an oval or circular shape if the vehicle 11 has a constant or near constant angular velocity. Based upon the estimated overall profile of the local map 97, the stitching sub-engine 89 may realign portions of the paved surface boundary 13 and/or the uncertainty bounds 99 to match the estimated profile. Thus, the output of the close-the-loop technique is a connected local map 97 representing a paved surface 27 that vehicles, such as the vehicle 11, may traverse in the future.

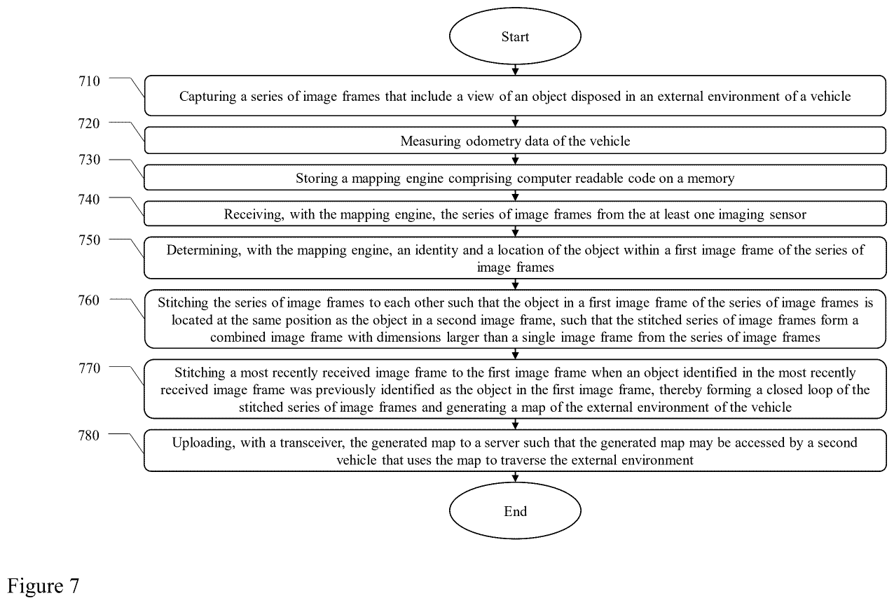

Turning to FIG. 7, FIG. 7 depicts a method for generating a map for a vehicle 11 and localizing the vehicle 11 on the map in accordance with one or more embodiments of the invention. While the various blocks in FIG. 7 are presented and described sequentially, one of ordinary skill in the art will appreciate that some or all of the blocks may be executed in a different order, may be combined or omitted, and some or all of the blocks may be executed in parallel and/or iteratively. Furthermore, the blocks may be performed actively or passively. Similarly, a single block can encompass multiple actions, or multiple blocks may be performed in the same physical action.

The method of FIG. 7 initiates at Step 710, which includes capturing a series of image frames that include a view including features disposed in an external environment of a vehicle 11. The series of image frames are captured by way of at least one imaging sensor 69, which includes a first camera 29, a second camera 31, a third camera 33, and a fourth camera 35. The imaging sensors 69 may include mono or stereo cameras, Light Detection and Ranging (LiDAR) sensors, radar sensors, ultrasonic sensors, infrared sensors, equivalent sensors known to a person skilled in the art, or a combination thereof.

In Step 720, the odometry sensors 36 measure odometry data 71 of the vehicle 11, including an orientation, a velocity, and an acceleration thereof. The odometry sensors 36 include a GPS unit 43, an IMU 45, and a wheel encoder 47. The GPS unit 43 provides a GPS position of the vehicle 11, derived through satellite triangulation, that is associated with a subsequently generated map. The IMU 45 and the wheel encoder 47 are configured to facilitate the collection of local movement data related to the vehicle 11. The local movement data, such as the odometry data 71, is stored in a lookup table and used by the stitching sub-engine 89 of the mapping engine 75 for IPM image 79 sequencing and corner alignment, among other purposes described herein.

Step 730 includes storing, with a memory 67, a mapping engine 75 including computer readable code. The memory 67 includes a non-transient storage medium such as Random Access Memory (RAM). The mapping engine 75 includes a perspective mapping algorithm 77, a semantic feature-based deep learning neural network, a stitching sub-engine 89, and a localization algorithm 91. The neural network includes an input layer 81, one or more hidden layers 83, and an output layer 85. Collectively, components of the mapping engine 75 serve to develop a local map 97 of the paved surface 27 that the vehicle 11 traverses, as well as other related functions described herein.

In Step 740, the mapping engine 75 receives the series of image frames from the at least one imaging sensor 69. In particular, a perspective mapping algorithm 77 of the mapping engine 75 receives images captured by the cameras 29-35 as image data 73, where the images include a view of the surrounding environment of the vehicle 11. From the image data 73, the mapping engine 75 uses a perspective mapping algorithm 77 to determine an Inverse Perspective Mapping (IPM) image 79. The IPM image 79 is a unified and distortion-corrected view of the paved surface 27, that is derived by transforming the plurality of image frames into a consistent, single perspective using the spatial relationships between the cameras 29-35.

In Step 750, the mapping engine 75 determines an identity and a location of a feature within a first image frame of the series of image frames (i.e., the IPM image 79). The mapping engine 75 performs feature detection by way of a semantic feature-based deep learning neural network with inputs of the odometry data 71 and the image data 73 (converted to IPM images 79 by way of the perspective mapping algorithm 77). The neural network (i.e., layers 81-85) extracts various features from the IPM Images 79, and associates each identified feature with its positional information. Thus, the series of IPM images 79 output at the output layer 85 includes numerous identified features and positions. As discussed above, textual descriptions of the features may be stored in a lookup table with the corresponding odometry information to facilitate the image stitching process discussed below.

In Step 760, the series of IPM images 79 are stitched to each other with a stitching sub-engine 89 of the mapping engine 75 such that an identified feature in a given IPM image 79 is located at the same position as the same identified feature in an adjacent IPM image 79. This process is iteratively repeated, where a “N^{th}” captured IPM image 79 is stitched to an “N−1” captured IPM image 79, until the IPM images 79 are stitched into a closed-loop form (i.e., an N^{th} image is stitched to a first or otherwise earlier captured image). As a result, the stitched series of image frames form a combined image frame with dimensions larger than a single image frame captured by a particular camera of the imaging sensors 69.

Step 770 includes stitching a most recently received IPM image 79 to the first IPM image 79. This occurs when the mapping engine 75 identifies a feature in the most recently received mapping engine 75 that was previously identified as the feature in the first mapping engine 75. In this case, the stitching sub-engine 89 stitches the most recently received IPM image 79 to the first IPM image 79 to form a closed loop of the stitched series of IPM images 79, which forms a local map 97 of the external environment of the vehicle.

Finally, in Step 780, a transceiver 65 uploads the generated local map 97 to a server 57 such that the generated local map 97 may be accessed by a second vehicle that uses the local map 97 to traverse the external environment. A GPS position of the vehicle 11 is associated with the local map 97 when the local map 97 is uploaded to the server 57. As multiple local maps 97 are uploaded, the server 57 organizes the local maps 97 based on their associated GPS coordinates to form a large scale global map 93. Subsequently, other vehicles, or the vehicle 11, may use a localization algorithm 91 as described herein to become localized on a local map 97 downloaded from the server 57. Thus, the overall impact of the local map 97 being uploaded and coalesced into the global map 93 is the formation of a semi-modular map that can be flexibly accessed with a low data transmission cost. This also provides the benefit of allowing the global map 93 to be crowd-sourced through the formation of the local maps 97 by a plurality of vehicles 11, shifting the logistical cost of manufacturing a global map 93 to the owners of the vehicles 11.

Accordingly, the aforementioned embodiments of the invention as disclosed relate to systems and methods useful in generating a map for a vehicle 11 and localizing the vehicle 11 on the map, thereby creating accessible and frequently updated crowdsourced maps for navigational and autonomous driving purposes. Although only a few example embodiments have been described in detail above, those skilled in the art will readily appreciate that many modifications are possible in the example embodiments without materially departing from the invention. For example, the paved surface 27 may include a paved surface boundary 13 of one or more simple geometric shapes that combine to form an overall complex shape (i.e., a square attached to a rectangle to form an “L” shape to match a strip mall layout). Further, the paved surface 27 may be either indoors or outdoors. In addition, the system 41 is not limited to generated maps only for paved surfaces 27 such as parking lots, but may, for example, generate a map of a street and localize the vehicle on the street using the generated map. Accordingly, all such modifications are intended to be included within the scope of this disclosure as defined in the following claims.

Furthermore, the compositions described herein may be free of any component, or composition not expressly recited or disclosed herein. Any method may lack any step not recited or disclosed herein. Likewise, the term “comprising” is considered synonymous with the term “including.” Whenever a method, composition, element, or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

What is claimed is:

1. A system for generating a map of a paved surface for a vehicle and localizing the vehicle on the map of the paved surface, the system comprising:
at least one imaging sensor configured to capture a series of image frames that include a view comprising features disposed in an external environment of the vehicle;
at least one vehicle odometry sensor configured to measure odometry information related to an orientation, a velocity, and an acceleration of the vehicle;
a memory configured to store a mapping engine comprising computer readable code;
a processor configured to execute the computer readable code forming the mapping engine,
where the computer readable code causes the processor to:
receive the series of image frames from the at least one imaging sensor;
determine an identity and a location of a feature within a first image frame of the series of image frames;
stitch the series of image frames to each other such that the feature in the first image frame of the series of image frames is located at a same position as the feature in a second image frame, wherein the stitched series of image frames form a combined image frame with dimensions larger than a single image frame from the series of image frames; and
stitch a most recently received image frame to the first image frame when a feature identified in the most recently received image frame was previously identified as the feature in the first image frame, thereby forming a closed loop of the stitched series of image frames and generating the map of the external environment of the vehicle; and
a transceiver configured to upload the map to a server such that the map is accessed by a second vehicle that uses the map to determine its position in relation to features of the external environment.

2. The system of claim 1, wherein the at least one vehicle odometry sensor comprises at least one of: a global positioning system (GPS) unit, an inertial measurement unit (IMU), and a wheel encoder.

3. The system of claim 1, wherein a GPS position of the vehicle is associated with the map when the map is uploaded to the server, and the server comprises a global map separated into a plurality of local maps of varying sizes organized based upon the GPS positions of the vehicles that generate the plurality of maps.

4. The system of claim 1, wherein the memory comprises a non-transient storage medium.

5. The system of claim 1, wherein the features disposed in the external environment of the vehicle comprise one or more of: parking lines, traffic signs, pillars, parked vehicles, sidewalks, trees, and grass.

6. The system of claim 1, wherein the mapping engine is further configured to remove dynamic features from the map.

7. The system of claim 1, wherein the vehicle is localized on the map by way of a localization algorithm configured to:
generate candidate positions of the vehicle on the map based upon the odometry information and the series of image frames;
assign each candidate position a correspondence score that represents a correlation between the odometry information, the series of image frames, and the features disposed in the external environment of the vehicle adjacent to the candidate position; and
determine that the vehicle is located at a particular candidate position having a highest correspondence score.

8. The system of claim 1, wherein a 6 degrees of freedom localized position of the vehicle is determined using an extended Kalman filter that has inputs of the at least one vehicle odometry sensor and the at least one imaging sensor.

9. The system of claim 1, wherein the map is updated by removing features from the map that were previously detected by a first vehicle and are not detected by the second vehicle that subsequently traverses the external environment.

10. The system of claim 7, wherein the localization algorithm comprises an Iterative Closest Point (ICP) algorithm, Random Sample Consensus (RANSAC) algorithm, bundle adjustment algorithm, or Scale-Invariant Feature Transform (SIFT) algorithm.

11. The system of claim 1, further comprising:
a plurality of imaging sensors including at least four cameras that capture a plurality of image frames;
wherein the mapping engine comprises an algorithm configured to generate an Inverse Perspective Mapping (IPM) image from the plurality of image frames, and
wherein the plurality of image sensors includes the at least one imaging sensor.

12. The system of claim 1, wherein a boundary of the map is defined according to a vehicle path of the vehicle on the paved surface, and the processor corrects the map to form a connected shape representative of the boundary after the stitched series of image frames form the closed loop.

13. A method for generating a map of a paved surface for a vehicle and localizing the vehicle on the map of the paved surface, the method comprising:
capturing, via at least one imaging sensor, a series of image frames that include a view comprising features disposed in an external environment of the vehicle;
measuring, via at least one vehicle odometry sensor, odometry information related to an orientation, a velocity, and an acceleration of the vehicle;
storing a mapping engine comprising computer readable code on a memory;
receiving, by executing the computer readable code that forms the mapping engine, the series of image frames from the at least one imaging sensor;
determining, with the mapping engine, an identity and a location of a feature within a first image frame of the series of image frames;
stitching, with the mapping engine, the series of image frames to each other such that the feature in the first image frame of the series of image frames is located at a same position as the feature in a second image frame, such that the stitched series of image frames form a combined image frame with dimensions larger than a single image frame from the series of image frames;
stitching, with the mapping engine, a most recently received image frame to the first image frame when a feature identified in the most recently received image frame was previously identified as the feature in the first image frame, thereby forming a closed loop of the stitched series of image frames and generating the map of the external environment of the vehicle; and
uploading, via a transceiver, the map to a server such that the map is accessed by a second vehicle that uses the map to traverse the external environment.

14. The method of claim 13, further comprising: associating a GPS position of the vehicle with the map when uploading the map to the server, the server comprising a global map separated into a plurality of local maps of varying sizes organized based upon the GPS positions of the vehicles that generate the plurality of maps.

15. The method of claim 13, further comprising: removing dynamic features from the map via the mapping engine.

16. The method of claim 13, further comprising: localizing the vehicle on the map by way of a localization algorithm, the localization algorithm comprising:
generating candidate positions of the vehicle on the map based upon the odometry information and the series of image frames;
assigning each candidate position a correspondence score that represents a correlation between the odometry information, the series of image frames, and the features disposed in the external environment of the vehicle adjacent to the candidate position; and
determining that the vehicle is located at a particular candidate position having a highest correspondence score.

17. The method of claim 13, further comprising: determining a 6 degrees of freedom localized position of the vehicle via an extended Kalman filter that has inputs of the at least one vehicle odometry sensor and the at least one imaging sensor.

18. The method of claim 16, wherein the localization algorithm comprises an Iterative Closest Point (ICP) algorithm, Random Sample Consensus (RANSAC) algorithm, bundle adjustment algorithm, or Scale-Invariant Feature Transform (SIFT) algorithm.

19. The method of claim 13, further comprising: updating the map by removing features from the map that were previously detected by a first vehicle and are no longer present in the external environment when traversed by the second vehicle, such that the second vehicle does not detect the features previously detected by the first vehicle.

20. The method of claim 13, further comprising: defining a boundary of the map according to a vehicle path of the vehicle on the paved surface, and correcting the map to form a connected shape representative of the boundary after the stitched series of image frames form the closed loop.
